(19) United States
(12) Patent Application Publication
(10) Pub. No.: US 2011/0194182 A1
(43) Pub. Date: Aug. 11, 2011

(54) Transparent Conductive Laminate Comprising Reflection Adjustment Layers

(75) Inventors: MING HONG HSU, HSINCHU HSIEN (TW); HSUAN TA CHEN, HSINCHU HSIEN (TW); CHUN KUANG LAI, HSINCHU HSIEN (TW)

(73) Assignee: USHINE PHOTONICS CORPORATION, Hsinchu Hsien (TW)

(21) Appl. No.: 13/014,176

(22) Filed: Jan. 26, 2011

(30) Foreign Application Priority Data
Feb. 6, 2010 (TW) 099103610

(51) Int. Cl. G02B 1/11

(52) U.S. Cl. 359/601

(57) ABSTRACT

An exemplary transparent conductive laminate includes an organic polymer transparent substrate, at least one set of reflection adjustment layers, and a transparent conductive layer. The set of reflection adjustment layers, sandwiched between the organic polymer transparent substrate and the transparent conductive layer, includes a first adjustment layer and a second adjustment layer. The root mean square value of differences between the reflectance of a combination of the organic polymer transparent substrate, the transparent conductive layer and the at least one set of reflection adjustment layers over the wavelength range of from 380 nm to 800 nm and the average reflectance of the combination of the organic polymer transparent substrate, the transparent conductive layer and the at least one set of reflection adjustment layers over the range of from 380 nm to 800 nm is less than 3%. The refractive index of the first adjustment layer ranges from 1.8 to 2.5, and its optical thickness ranges from 10 nm to 100 nm. The refractive index of the second adjustment layer ranges from 1.3 to 1.6, and its optical thickness ranges from 10 nm to 250 nm.

### BACKGROUND OF THE INVENTION

1. Field of the Invention

The present invention relates to a transparent conductive laminate comprising reflection adjustment layers.

2. Description of the Related Art

With the rapid advances in technology, personal electronics products are now extremely lightweight, thin, and compact. Touch panels have already become a necessary input device. They allow intuitive entry of commands and operation, with entirely new interaction between the user and the devices. Thus, touch panels are popularly applied in different types of personal electronics products. In addition, touch panels are easy to use and suitable as an input device while downloading multimedia information, and have advantages such as good mechanical endurance, fast response, compact size, and easy manipulation.

According to working principles and the transmission media on which they rely, touch panels can be classified into several types: resistive type, capacitive type, infrared type, and electromagnetic induction type. Of these, the resistive type of touch panel is the most popular on the market. Projected capacitive touch panels allow multi-touch operation. Users can simultaneously input commands and manipulate images manually. The projected capacitive touch panels have become a popular product in recent years. The resistive and capacitive touch panels need a transparent conductive layer (TCL) for generating interrupt signals induced by touch operation, and the TCL is primarily made of indium tin oxide.

The capacitive touch technology can be divided into the surface capacitive touch technology and the projected capacitive touch technology. If multi-touch operation is required, the projected capacitive touch technology is the only option. A projected capacitive touch panel may include a TCL, which can be patterned by an etching process and provided to cause a change of capacitance when a conductor (i.e., a user's finger) is placed close to the surface of the projected capacitive touch panel, and the location of the conductor on the surface of the touch panel can be calculated according to the detection results of the change of capacitance.

A projected capacitive touch panel can be manufactured by bonding two glass substrates, each of which has a patterned TCL. The production yield of bonding of two glass substrates is low. For example, bubbles may be present at the bonding interface. If bubbles exist at the bonding interface, the bonded glass substrates usually must be discarded. The low production yield problem becomes more critical to the bonding of medium- and large-size glass substrates because material waste is significant. In contrast, a projected capacitive touch panel can include a single substrate having two transparent conductive layers. The transparent conductive layers can be on the same surface or on opposite surfaces. Manufacture of such a single substrate requires a complex etching process and extensive layout engineering. Due to such complex manufacturing requirements, manufacturers use transparent plastic substrates instead of glass substrates for better production yield and simpler manufacturing processes. However, with the limited low glass transition temperature (Tg) of plastic substrates, the high temperature film formation process cannot be applied to obtain a transparent conductive layer of better quality. Moreover, the transmittance of a plastic substrate is lower than that of a glass substrate, and the refractive index of a plastic substrate is higher than that of a glass substrate. As such, a transparent electrically conductive laminate manufactured using a plastic substrate has low transmittance and causes large differences in color and luster when patterns are formed, adversely affecting the optical characteristics of the touch panel.

Thus, in order to resolve the above-described optical limitation, one or more buffer layers are deposited between a TCL and a plastic substrate of the present technology to achieve low reflection. The purpose of adding one or more buffer layer is to minimize the reflection of visible light with wavelengths between 380 nm and 500 nm in transparent conductive laminates. However, because a portion of light passes through the solid portion of the transparent conductive layer while another portion of light passes through the hollow portion of the transparent conductive layer, a patterned transparent conductive layer shows apparent chromatic difference. As a result, users may visibly sense the existence of an etched pattern. This seriously reduces the image quality of a touch screen.

With the human eye's sensitivity to hue, the chromatic difference caused by a transparent conductive layer that is partially hollow and partially solid can be indiscernible only if the value differences, Δa* and Δb*, are sufficiently small. According to experience, Δa* and Δb* must be smaller than 1.0. (a* and b* are coordinate values of the CIE L*a*b* system originated in 1976.)

In summary, a transparent conductive laminate having a better structure is needed by the touch screen industry in order to resolve the issues that exist with the application of flexible transparent conductive laminates to capacitive touch panels.

### SUMMARY OF THE INVENTION

Each of the embodiments of the present invention discloses a transparent conductive laminate comprising reflection adjustment layers, in which at least one set of reflection adjustment layers is formed between a transparent substrate and a transparent conductive layer so that the reflectance between 380 nm and 800 nm may vary uniformly, and the average value of the reflectance between 380 nm and 800 nm can be low. Consequently, the differences, Δa* and Δb*, between the solid portion and the hollow portion of the transparent conductive layer, can be kept below 1, and the transparent conductive laminate can have a better visual light transmittance (greater than 90%) before it is patterned.

Each of the embodiments of the present invention discloses a transparent conductive laminate comprising reflection adjustment layers, in which at least one set of reflection adjustment layers is formed between a transparent substrate and a transparent conductive layer so that the reflectance between 380 nm and 800 nm may vary uniformly, and the variation range of the reflectance between 380 nm and 800 nm is narrow. Consequently, the edges of the solid portion are invisible.

One embodiment of the present invention discloses a transparent conductive laminate comprising reflection adjustment layers including an organic polymer transparent substrate, at least one set of reflection adjustment layers, and a transparent conductive layer. The at least one set of reflection adjustment layers is sandwiched between the organic polymer transparent substrate and the transparent conductive layer. The at least one set of reflection adjustment layers comprises a first adjustment layer and a second adjustment layer. The first adjustment layer has a refractive index in a range of from 1.8 to 2.5, and the material of the first adjustment layer can be cerium oxide, titanium dioxide, niobium pentoxide, zirconium dioxide, or zinc oxide. The optical thickness of the first adjustment layer is in a range of 10 nm to 100 nm. The second adjustment layer has a refractive index in a range of from 1.3 to 1.6. The material of the second adjustment layer is magnesium fluoride, silicon dioxide, or aluminum oxide. The optical thickness is in a range of from 10 nm to 250 nm.

One embodiment of the present invention discloses a transparent conductive laminate comprising reflection adjustment layers including an organic polymer transparent substrate, at least one set of reflection adjustment layers, and a transparent conductive layer. The at least one set of reflection adjustment layers is sandwiched between the organic polymer transparent substrate and the transparent conductive layer. The at least one set of reflection adjustment layers comprises a first adjustment layer and a second adjustment layer, wherein the first adjustment layer and the second adjustment layer are configured such that the performance of the organic polymer transparent substrate, the transparent conductive layer and the at least one set of reflection adjustment layers over the wavelength range of from 380 nm to 800 nm meets the following conditions: The root mean square value of differences between the reflectance measured over the wavelength range of from 380 nm to 800 nm and the averaged reflectance of the measured reflectance is less than 3%, preferably less than 2%, and most preferably less than 1%.

In one embodiment of the present invention, the performance of the organic polymer transparent substrate, the transparent conductive layer and the at least one set of reflection adjustment layers over the wavelength range of from 380 nm to 800 nm further meets the following conditions: The average value of reflectance differences between the solid portion and the hollow portion over the range of from 380 nm to 800 nm is less than 3%, preferably less than 2%, and most preferably less than 1%.

The transparent conductive laminate of one embodiment of the present invention further comprises an inorganic material layer, an organic material layer, or a metal oxide layer deposited between the organic polymer transparent substrate and the at least one set of reflection adjustment layers for improving the adhesion between the organic polymer transparent substrate and the at least one set of reflection adjustment layers. The inorganic material layer, organic material layer, or metal oxide layer has a physical thickness of less than 10 nm, preferably 2 to 5 nm. The inorganic material layer, organic material layer, or metal oxide layer includes carbon (C), silicon (Si), or SiOₓ, where x can be either 1 or 2. Because the inorganic material layer, organic material layer, or metal oxide layer is very thin, it can improve the adhesion between the organic polymer transparent substrate and the at least one set of reflection adjustment layers without affecting the optical performance of the transparent conductive laminate.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 is a cross-sectional view showing a transparent conductive laminate according to one embodiment of the present invention;

FIG. 2 is a cross-sectional view showing a transparent conductive laminate according to one embodiment of the present invention;

FIG. 3 is a plot showing reflectance vs. wavelength curves demonstrating the performance of the solid portion of a transparent conductive layer according to one embodiment of the present invention; and

FIG. 4 is a plot showing the relationship between wavelengths and the reflectance R₁(λ) and R₂(λ) of a solid portion A1 and a hollow portion A1 according to one embodiment of the present invention.

### DETAILED DESCRIPTION OF THE INVENTION

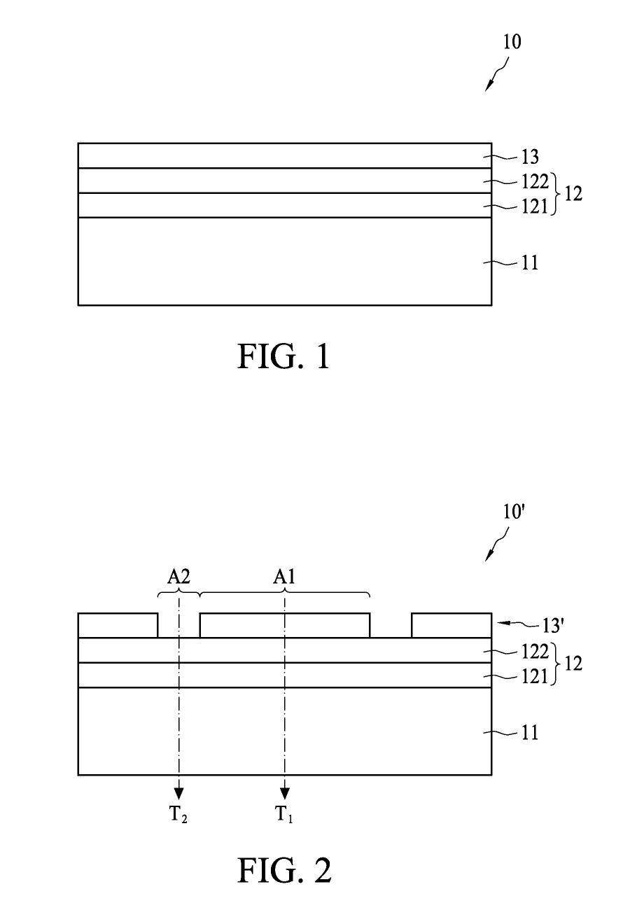

FIG. 1 is a cross-sectional view showing a transparent conductive laminate according to one embodiment of the present invention. A transparent conductive laminate 10 comprises an organic polymer transparent substrate 11, at least one set of reflection adjustment layers 12, and a transparent conductive layer 13. The set of reflection adjustment layers 12 is sandwiched between the organic polymer transparent substrate 11 and the transparent conductive layer 13. The set of reflection adjustment layers 12 comprises a first adjustment layer 121 and a second adjustment layer 122, which are sequentially stacked on the surface of the organic polymer transparent substrate 11. The first adjustment layer 121 can have a refractive index in a range of from 1.8 to 2.5 and an optical thickness (reflectance multiplied by physical thickness) in a range of from 10 nm to 100 nm. The second adjustment layer 122 can have a refractive index in a range of from 1.3 to 1.6 and an optical thickness in a range of from 10 nm to 250 nm. Thus, the refractive index of the second adjustment layer 122 is greater than that of the first adjustment layer 121.

The material of the first adjustment layer 121 may be cerium oxide (CeO₂), titanium dioxide (TiO₂), niobium pentoxide (Nb₂O₅), zirconium dioxide (ZrO₂), or zinc oxide (ZnO). The second adjustment layer 122 can be made of material such as magnesium fluoride (MgF₂), silicon dioxide (SiO₂), or aluminum oxide (Al₂O₃), having an optical thickness in a range of 10 nm to 250 nm.

The material of the transparent conductive layer 13 can be a transparent metal oxide semiconductor such as indium tin oxide (ITO), indium zinc oxide (IZO), aluminum zinc oxide (AZO), or antimony-doped tin oxide (ATO). The metal oxide semiconductor can have a refractive index in a range of from 1.8 to 2.2. The transparent conductive layer 13 can have an optical thickness in a range of from 10 nm to 220 nm.

The organic polymer transparent substrate 11 can be a general optical-grade transparent flexible plastic substrate with a refractive index ranging from 1.4 to 1.7. The material of the organic polymer transparent substrate 11 can be polyethylene terephthalate (PET), polyarylate (PAR), polyether sulfone (PES), polyethylene naphthalate (PEN), or polycarbonate (PC). The above polymers have different polymer structures, and therefore exhibit different optical, heat resistant, and chemical resistant characteristics. In particular, the plastic substrate for touch panels should have better optical characteristics. For example, when the plastic substrate is irradiated with light with a wavelength of 550 nm, its visual light transmittance should be greater than 90%.

The transparent conductive laminate 10 of another embodiment of the present invention further comprises a medium layer, which can be an inorganic material layer, an organic material layer, or a metal oxide layer. The medium layer can be deposited between the organic polymer transparent substrate 11 and the at least one set of reflection adjustment layers 12 for improving the adhesion between the organic polymer transparent substrate 11 and the at least one set of reflection adjustment layers 12. The medium layer can have a physical thickness below 10 nm, preferably ranging from 2 to 5 nm. The inorganic material layer, organic material layer, or metal oxide layer may include carbon (C), silicon (Si), or SiOₓ, where x can be either 1 or 2. Because the inorganic material layer, organic material layer, or metal oxide layer is very thin, it can improve the adhesion between the organic polymer transparent substrate 11 and the at least one set of reflection adjustment layers 12 without affecting the optical performance of the transparent conductive laminate 10.

FIG. 2 is a cross-sectional view showing a transparent conductive laminate 10′ according to one embodiment of the present invention. Compared with the transparent conductive laminate 10 in FIG. 1, the transparent conductive layer 13′ of the transparent conductive laminate 10′ in FIG. 2 is formed through an etching process. Thus, the transparent conductive layer 13′ has a solid portion A1 and a hollow portion A2, and the light passing through the solid portion A1 is indicated by T₁ and the light passing through the hollow portion A2 is indicated by T₂.

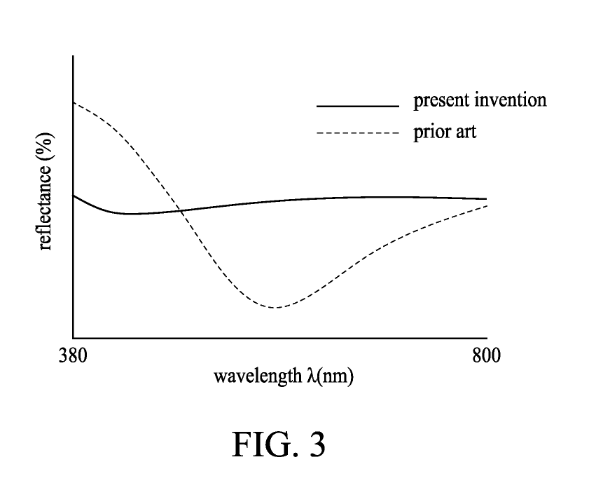

FIG. 3 is a plot showing reflectance vs. wavelength curves demonstrating the performance of the solid portion of a transparent conductive layer according to one embodiment of the present invention. In FIG. 3, the reflectance of the solid portion A1 varies substantially uniformly as the wavelength of passing light T₁ increases. Comparatively, the reflectance of a prior art transparent conductive layer changes significantly as the wavelength of passing light increases. Moreover, the root mean square value of the reflectance over the wavelength range of from 380 nm to 800 nm is significantly low. In other words, the root mean square value ΔRrms of the differences between the reflectance R(λ) over the wavelength range of from 380 nm to 800 nm and the average reflectance R(λₐᵥₑ) over the range of from 380 nm to 800 nm is less than 3% when changing the physical thicknesses or the refractive indexes of the first adjustment layer 121 and the second adjustment layer 122. ΔRrms can be calculated by the following equation (1):

$$ΔRms = \sqrt{\frac{{\int }_{λ = 380}^{800} {( R ( λ ) - {R}_{ave} )}^{2} d λ}{( 800 - 380 )}} \qquad ( 1 )$$

where

$${R}_{ave} = \frac{{\int }_{λ = 380}^{800} R ( λ ) d λ}{( 800 - 380 )} ;$$

that is, Rₐᵥₑ is the average reflectance over the range of from 380 nm to 800 nm.

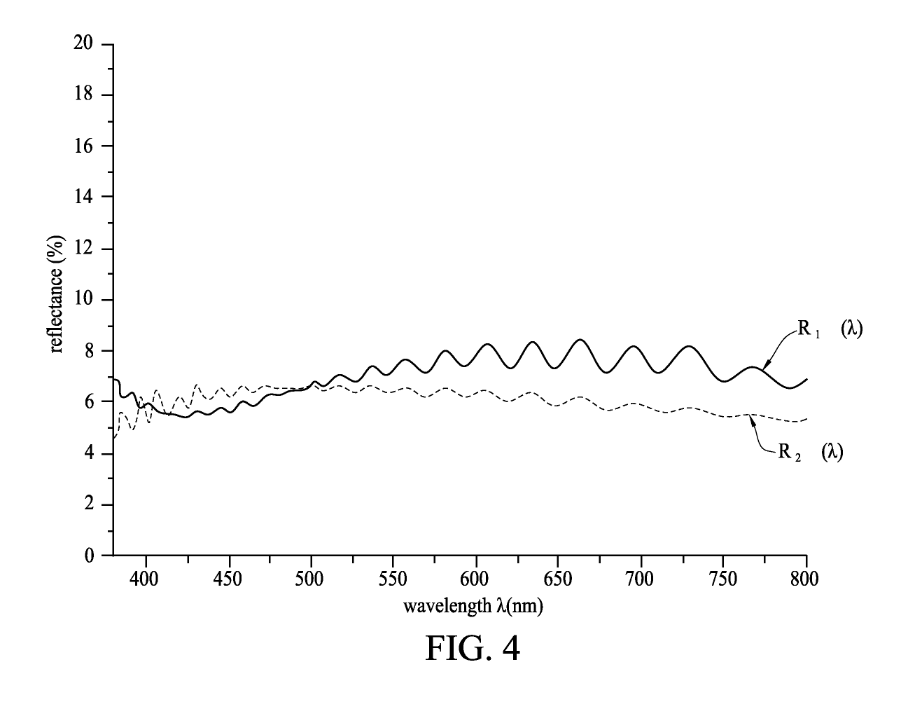

As shown in FIG. 2, R₁(λ) and R₂(λ) separately represent the reflectance of the solid portion A1 and the reflectance of the hollow portion. Referring to FIG. 4, in the range of from 380 nm to 800 nm, the reflectance difference ΔR(λ)=R₁(λ)−R₂(λ) is small, and, due to the small ΔRrms, the change of ΔR(λ) is gentle.

The adjustment of the reflectance and the optical film thickness of the first adjustment layer 121 and the second adjustment layer 122 over the range of from 380 nm to 800 nm can minimize φR(λ), and when an average value, φRₐᵥₑ, is less than 3%, the chromatic difference between the solid portion A1 and the hollow portion A2 cannot be visually discerned. In addition, φRₐᵥₑ can be calculated by the following equation (2):

$$Δ {R}_{ave} = \frac{{\int }_{λ = 380}^{800} \vert {R}_{1} ( λ ) - {R}_{2} ( λ ) \vert d λ}{( 800 - 380 )} \qquad ( 2 )$$

Under the condition that the above-mentioned ΔRrms is less than 3% and the φRₐᵥₑ is less than 3%, a transparent conductive laminate 10, the transparent conductive layer of which is etched to have the solid portion A1 and the hollow portion A2 as shown in FIG. 2, shows no significant chromatic difference. The values Δa* and Δb* can be calculated according to the transmission spectrum of light T₁ and T₂, or can be measured using a colorimeter. In the present embodiment, Δa* and Δb* are difference values of the coordinate values a* and b* of the CIE (Commission Internationale de l'Eclairage) L*a*b* system originated in 1976.

According to the above-mentioned design concept, one embodiment of a transparent conductive laminate is proposed and its features are demonstrated in Table 1. The PET substrate has a thickness of 125 micrometers; the first adjustment layer is of titanium dioxide; the second adjustment layer is of silicon dioxide; and the transparent conductive layer is of indium tin oxide. The Δa* and Δb* can be limited below 1, and the experimental data shows that the chromatic difference of the transparent conductive laminate is small before or after the transparent conductive laminate is patterned. Accordingly, the edges of the pattern are invisible.

Table 1 shows the experimental data for a transparent conductive laminate according to one embodiment of the present invention. A substantially flat curve as shown in FIG. 4 can be obtained by suitably designing the first adjustment layer and the second adjustment layer. Through calculations, ΔRrms is 0.77%, φRₐᵥₑ is 0.75%, and in the chromatic difference, the Δa* is 0.27 and the Δb* is 0.21. In short, the edges of the pattern are invisible, and the visual light transmittance is above 90%.

Table 1 shows experimental dat of one embodiment of the present invention and a comparative example.

| | | Comparative |
|---|---|---|
| PET substrate with thickness of 125 μm | Example | example |
| The optical thickness of the first adjustment | 13 | 27 |
| layer (nm) | | |
| The optical thickness of the second | 79 | 102 |
| adjustment layer (nm) | | |
| The optical thickness of the conductive layer | 36 | 36 |
| (nm) | | |
| ΔRrms (%) | 0.77 | 3.0 |
| ΔRₐᵥₑ (%) | 0.75 | 1.97 |
| VLT (%) | 91.4 | 94.7 |
| Δa* | 0.27 | 1.65 |
| Δb* | 0.21 | 1.3 |
| ΔC¹ | 0.67 | 1.97 |
| Chromatic difference | Insignificant | significant |

¹ΔC = \sqrt{(Δa*)² + (Δb*)²}

The comparative example is a transparent conductive laminate. The comparative example has a low reflectance over the wavelength range of from 380 nm to 500 nm, and high visual light transmittance (above 94%). The comparative example has a value Δa* of 1.65 and its Δb* is 1.3, causing significant chromatic difference. Therefore, the conventional transparent conductive laminate having low reflectance and high visual light transmittance cannot meet the requirements of a projected capacitive touch panel.

The transparent conductive laminate of the present invention may include multiple sets of reflection adjustment layers 12. The reflectance of the transparent conductive laminate over the wavelength range of from 380 nm to 800 nm can be adjusted such that ΔRrms and the φRₐᵥₑ are less than 3% so that the visual light transmittance can be above 90%. Simultaneously, the Δa* and the Δb* can be limited below 1. Preferably, ΔRrms and the φRₐᵥₑ are less than 2%, more preferably, less than 1%. The above experimental results show the transparent conductive laminate is superior to a prior art laminate.

The above-described embodiments of the present invention are intended to be illustrative only. Numerous alternative embodiments may be devised by persons skilled in the art without departing from the scope of the following claims.

What is claimed is:

1. A transparent conductive laminate comprising reflection adjustment layers, comprising:
an organic polymer transparent substrate;
a transparent conductive layer; and
at least one set of reflection adjustment layers comprising a first adjustment layer and a second adjustment layer, wherein the at least one set of reflection adjustment layers is sandwiched between the organic polymer transparent substrate and the transparent conductive layer;
wherein the first adjustment layer and the second adjustment layer are configured such that a root mean square value of differences between reflectance of a combination of the organic polymer transparent substrate, the transparent conductive layer and the at least one set of reflection adjustment layers and an averaged reflectance of the combination of the organic polymer transparent substrate, the transparent conductive layer and the at least one set of reflection adjustment layers over the range of from 380 nm to 800 nm is less than 3%.

2. The transparent conductive laminate comprising reflection adjustment layers of claim 1, wherein the root mean square value of the differences between the reflectance over the wavelength range of from 380 nm to 800 nm and the average reflectance over the range of from 380 nm to 800 nm is less than 2%.

3. The transparent conductive laminate comprising reflection adjustment layers of claim 2, wherein the root mean square value of the differences between the reflectance over the wavelength range of from 380 nm to 800 nm and the average reflectance over the range of from 380 nm to 800 nm is less than 1%.

4. The transparent conductive laminate comprising reflection adjustment layers of claim 1, further comprising a medium layer, wherein the medium layer is an inorganic material layer, an organic material layer, or a metal oxide layer, and has a physical thickness of less than 10 nm.

5. The transparent conductive laminate comprising reflection adjustment layers of claim 4, wherein the physical thickness of the medium layer is between 2 to 5 nm.

6. The transparent conductive laminate comprising reflection adjustment layers of claim 4, wherein the medium layer includes carbon (C), silicon (Si), or SiOₓ, where x is either 1 or 2.

7. The transparent conductive laminate comprising reflection adjustment layers of claim 1, wherein the transparent conductive layer includes a solid portion and a hollow portion.

8. The transparent conductive laminate comprising reflection adjustment layers of claim 7, wherein an average value of reflectance differences between the solid portion and the hollow portion over the range of from 380 nm to 800 nm is less than 3%.

9. The transparent conductive laminate comprising reflection adjustment layers of claim 8, wherein the average value of reflectance differences between the solid portion and the hollow portion over the range of from 380 nm to 800 nm is less than 2%.

10. The transparent conductive laminate comprising reflection adjustment layers of claim 8, wherein the average value of reflectance differences between the solid portion and the hollow portion over the range of from 380 nm to 800 nm is less than 1%.

11. The transparent conductive laminate comprising reflection adjustment layers of claim 7, wherein a difference value, Δa*, between the solid portion and the hollow portion is less than 1, wherein a* is a coordinate value in the CIE L*a*b* system.

12. The transparent conductive laminate comprising reflection adjustment layers of claim 7, wherein a difference value, Δb*, between the solid portion and the hollow portion is less than 1, wherein b* is a coordinate value in the CIE L*a*b* system.

13. The transparent conductive laminate comprising reflection adjustment layers of claim 1, wherein the transparent conductive layer is of metal oxide semiconductor.

14. The transparent conductive laminate comprising reflection adjustment layers of claim 13, wherein the metal oxide semiconductor includes indium tin oxide, indium zinc oxide, aluminum zinc oxide, and antimony-doped tin oxide.

15. The transparent conductive laminate comprising reflection adjustment layers of claim 13, wherein the metal oxide semiconductor has a refractive index in a range of from 1.8 to 2.2 and an optical thickness in a range of from 10 nm to 220 nm.

16. The transparent conductive laminate comprising reflection adjustment layers of claim 1, wherein the organic polymer transparent substrate is of polyethylene terephthalate, polyarylate, polyether sulfone, polyethylene naphthalate or polycarbonate, and has a refractive index in a range of from 1.4 to 1.7.

17. The transparent conductive laminate comprising reflection adjustment layers of claim 1, wherein the first adjustment layer and the second adjustment layer are sequentially stacked on a surface of the organic polymer transparent substrate.

18. The transparent conductive laminate comprising reflection adjustment layers of claim 1, wherein the first adjustment layer has a refractive index in a range of from 1.8 to 2.5 and has an optical thickness in a range of 10 nm to 100 nm; and the second adjustment layer has a refractive index in a range of from 1.3 to 1.6 and has an optical thickness in a range of 10 nm to 250 nm.

19. The transparent conductive laminate comprising reflection adjustment layers of claim 1, wherein the material of the first adjustment layer is cerium oxide, titanium dioxide, Niobium pentoxide, Zirconium dioxide, or zinc oxide.

20. The transparent conductive laminate comprising reflection adjustment layers of claim 1, wherein the material of the second adjustment layer is magnesium fluoride, silicon dioxide, or aluminum oxide.
